(19) United States
(12) Patent Application Publication
(10) Pub. No.: US 2004/0170148 A1
(43) Pub. Date: Sep. 2, 2004

(54) Frequency hopping control channel in a radio communication system

(76) Inventors: Jarri Parkkinen, Oulu (FI); Esa Jarvela, Kempele (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/482,042

(22) PCT Filed: Jul. 2, 2001
(86) PCT No.: PCT/EP01/07535

(51) Int. Cl. H04J 3/00; H04B 7/212

(52) U.S. Cl. 370/337; 370/347

(57) ABSTRACT

The invention relates to a method for positioning mandatory time division multiple access (TDMA) frames which are mandatory to be transmitted during discontinuous transmissions (DTX) of TDMA frames in traffic channels (TCH) by a fixed sub-system of a radio communications system. It is assumed that said TDMA frames are transmitted using cyclic frequency hopping with two different frequencies. In order to improve air interface measurement methods in a radio access system, it is proposed that said mandatory TDMA frames are positioned for each sub-channel that can be employed as TCH in a way that said mandatory TDMA frames are always transmitted using both of said two different frequencies in the respective sub-channel within a predetermined number of TDMA frames. The invention equally relates to a corresponding radio communications network, a corresponding base station and mobile terminal and a corresponding subset of mandatory TDMA frames.

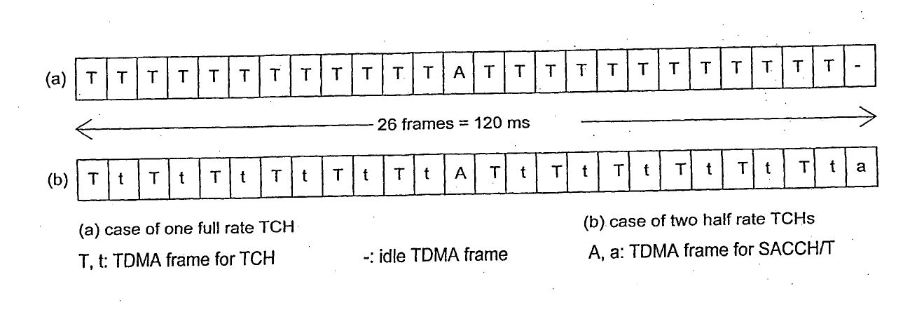

### FIELD OF THE INVENTION

The invention relates to a method for positioning mandatory time division multiple access (TDMA) frames which are mandatory to be transmitted during discontinuous transmissions (DTX) of TDMA frames in traffic channels (TCH) by a fixed sub-system of a radio communications system. The invention equally relates to a radio communications system, to a fixed sub-system and a mobile terminal for a radio communications system, and to a subset of TDMA frames.

### BACKGROUND OF THE INVENTION

In radio communications system, radio signals are transmitted via the air interface between a fixed sub-system, which can comprise e.g. a base station, and a mobile terminal. It is regularly an aim in such systems to use the air interface efficiently, e.g. in order to increase the capacity, to improve the quality of transmitted signals or to reduce the power consumption. It is known to employ to this end techniques like TDMA, frequency division multiple access (FDMA), half rate transmissions, DTX, frequency hopping, and measurements of received signal levels. In certain situations, a combination of these techniques according to current technical specifications results in an inconsistency, which will be demonstrated in the following for a GSM (Global System for Mobile communications). However, the problem is of relevance for other systems like EDGE (Enhanced Data-rates for GSM Evolution) as well.

Communications systems using TDMA techniques, like GSM, employ consecutive TDMA frames for transmitting signals between base stations and mobile terminals. Each TDMA frame is composed of 8 time slots, the transmission in each time slot being referred to as burst. When in addition FDMA is employed, the combination of a sequence of one of the time slots in each TDMA frame and of a specific sequence of radio frequency channels constitutes a physical channel.

The physical channels employed for carrying user information streams, i.e. encoded speech and data, are the traffic channels (TCH). Traffic channels can be either full rate or half rate channels, as described e.g. in the technical specification 3GPP TS 45.001 V4.0.1 (2000-10) “3rd Generation Partnership Project; Technical Specification Group GERAN; Digital cellular telecommunications system (Phase 2+); Physical layer on the radio path; General description (Release 4)”.

In full rate channels, a specific time slot of each of the sequence of TDMA frames can be employed for one connection. One TDMA frame in each TDMA multiframe comprising 26 TDMA frames, however, is reserved as slow TCH associated control channel (SACCH/T) for channel maintenance and channel control purposes. This is illustrated in the upper part of the only figure taken from the above cited specification TS 45.001. Part a) of the FIGURE shows a sequence of 26 TDMA frames of a total duration of 120 ms. In this sequence, “T” indicates the TDMA frames employed for transmitting user data or speech, which are frames 0-11 and 13-24. In addition, “A” indicates the SACCH/T frame, which is frame 12, and “-” indicates an idle frame, frame 25.

Alternatively to full rate channels, half rate channels can be employed as TCH for increasing the capacity of the system. In half rate mode, the TDMA frames used for the transmission of user data or speech are alternately assigned to a first sub-channel sub0 and to a second sub-channel sub1. For each connection between a base station and a mobile terminal of the communications system, only the TDMA frames of an assigned one of the sub-channels can then be employed for transmissions. For each of the sub-channels, a SACCH-frame is provided in each TDMA multiframe. The distribution of the frames for half rate channels is illustrated in part b) of the only FIGURE showing again a sequence of 26 TDMA frames. In this sequence, “T” indicates the TDMA frames employed for transmissions of user data or speech in a first sub-channel sub0, and “t” the TDMA frames employed for transmissions of user data or speech in a second sub-channel sub1. “T” and “t” frames alternate in frames 0-11 and 13-24. “A” indicates in the sequence of part b) of the FIGURE the SACCH/T frame associated to the first sub-channel sub0, which is frame number 12, and “a” indicates the SACCH/T frame associated to the second sub-channel sub1, frame number 25.

Other physical channels are employed i.a. for carrying a broadcast control channel BCCH. A broadcast control channel is a point-to-multipoint uni-directional control channel, from the fixed sub-system to the mobile terminal.

For a further increase of capacity, a discontinuous transmission DTX can be employed, which suspends radio transmission during silent periods. This leads at the same time to a reduction of the interference between different cells of the system.

When DTX is employed on a traffic channel, it is possible that not all TDMA frames are transmitted. However, it is specified in the technical specification 3GPP TS 45.008 V5.1.0 (2001-04): “3rd Generation Partnership Project; Technical Specification Group GSM/EDGE Radio Access Network; Digital cellular telecommunications system (Phase 2+); Radio subsystem link control (Release 5)” that in any case a subset of frames shall be transmitted for each sub-channel. For sub-channel sub0 used for speech transmissions, these are frames 0, 2, 4, 6, 52, 54, 56, and 58 of each SACCH multiframe comprising 104 TDMA frames. For speech transmissions, a silence descriptor (SID) frame is transmitted in the determined frames whenever no signaling or speech is to be transmitted. This SID frame comprises comfort noise parameters determined to avoid that the background acoustic noise, which is transmitted together with the speech, disappears as well when the radio transmission is cut.

The respective propagation conditions on the air interface depend i.a. on the radio frequency employed. An improvement of the air interface can be achieved by employing frequency hopping. Frequency hopping enables an operator to provide diversity on one transmission link and to average the quality on all communications due to interference diversity. In slow frequency hopping, the frequency is changed from one TDMA frame to the next. A base station using two transceivers (TRX) for cyclic base band (BB) hopping, for example, may transmit the frames of a sequence of TDMA frames, like the sequences depicted in the only FIGURE, alternately with two frequencies. The respective other frequency can then be employed in another sequence of TDMA frames. One of the carriers can be employed for example in addition for transmitting BCCH frames. Frequency hopping is described as well in the above cited specification TS 45.001 and in the technical specification 3GPP TS 45.002 V5.1.0 (2001-04): “3rd Generation Partnership Project; Technical Specification Group GSM/EDGE Radio Access Network; Digital cellular telecommunications system (Phase 2+); Multiplexing and multiple access on the radio path (Release 5)”.

In the equally above cited specification TS 45.008, it is further specified that the handover and radio frequency (RF) power control processes are based on radio link measurements. Each mobile terminal measures to therefore the level of received signals and transmits a corresponding value RXLEV to the base station.

For each channel, the determined parameter values RXLEV are supposed to be the average of received signal level measurement samples in dBm taken on that channel within a reporting period of a length of one SACCH multiframe, which SACCH multiframe contains 104 TDMA frames. Specification TS 45.008 further requests that for transmission to the base station the measured signal level is mapped to an RXLEV value between 0 and 63, depending on the measured signal strength in dBm. This value may then be employed as a criterion in the RF power control and handover processes.

Two different parameters RXLEV are defined for the signal level, both being determined by the mobile terminal and transmitted to the base station. A first parameter is referred to by RXLEV_FULL, which is the RXLEV for the full set of TCH and SACCH frames of one SACCH multiframe, or, in case of half-rate transmission, of a sub-channel of a SACCH multiframe. A second parameter is referred to by RXLEV_SUB, which is the RXLEV for the subset of 4 SACCH/T frames and the SID frames of one SACCH multiframe, or, in case of half-rate transmission, of a sub-channel of a SACCH multiframe.

In the above cited specification TS 45.008, it is also determined, however, that if frequency hopping is being used on the associated physical channel and if, in the BCCH Cell Options, a Power Control Indicator (PWRC) is set, measurements on the bursts on the BCCH frequency shall not be used in the RXLEV averaging process.

This requirement may leads to a problem in DTX half rate transmissions using cyclic BB-hopping with two different frequencies. In such a situation, the eight SID frames of the specified subset for speech for sub-channel sub0 and the four associated SACCH frames, which SID and SACCH frames are to be used for determining the RXLEV_SUB, are all sent using the same frequency. If this frequency happens to be the frequency used for the BCCH, the mobile terminal is thus not allowed at all to determine a RXLEV_SUB value based on measurements of the reception level of signals, if the PWRC bit is set.

In practice, terminals then usually report a fixed value for the RXLEV_SUB, e.g. 0 or 63, to the base station. That means, however, that while the PWRC is set, no useful values are provided to the radio access network.

The problem does not exist in the half rate sub-channel sub1, since in this sub-channel, a different frequency is used for the SID-frames and the SACCH/T frames associated to the second sub-channel.

### SUMMARY OF THE INVENTION

It is an object of the invention to improve air interface measurements in a radio access system.

This object is reached with a method for positioning mandatory TDMA frames which are mandatory to be transmitted during discontinuous transmissions of TDMA frames in traffic channels by a fixed sub-system of a radio communications system. The TDMA frames are assumed to be transmitted using cyclic frequency hopping with two different frequencies. According to the proposed method, the mandatory TDMA frames are positioned for each channel that can be employed as TCH in a way that the mandatory TDMA frames are always transmitted using both of the two different frequencies in the respective channel within a predetermined number of TDMA frames.

The object is equally reached with a communications system comprising a fixed sub-system and a mobile terminal. The fixed sub-system includes transmitting means capable of transmitting signals in TDMA frames and of employing for the transmission of TDMA frames of a TCH a cyclic frequency hopping with two different frequencies. The transmitting means can be for instance two transceivers but it could also be one transceiver capable of transmitting on several frequencies simultaneously if such transceivers become available. The fixed sub-system further includes processing means for positioning mandatory TDMA frames during discontinuous transmissions in a TCH according to the method of the invention. The mobile terminal in turn includes means for receiving the mandatory TDMA frames and means for measuring the reception level of the received mandatory TDMA frames.

Finally, the object is reached with a corresponding fixed sub-system and a corresponding mobile terminal. The fixed sub-system can be e.g. a base station or a radio access network.

The invention proceeds from the idea that in contrast to the requirements by the above cited specification TS 45.008, the mandatory TDMA frames transmitted during discontinuous transmissions can be placed for all TCHs into frames using different frequencies. Since according to the above cited specification TS 45.008, frequency hopping is not to be employed for the physical channel of the BCCH, it is thus avoided that in some situations exclusively the frequency used for the broadcast control channel is employed. Consequently, it can prevented that at certain times default values have to be transmitted. Thereby, call handling can be improved, since the call handling can rely on measured signal levels which are reported continuously. This results in an optimized usage of traffic channels and less call failures in certain situations.

Preferred embodiments of the invention become apparent from the subclaims.

The mandatory TDMA frames assigned to a TCH are preferably on the one hand SACCH/T frames. On the other hand, they are preferably frames of a predetermined subset of TDMA frames. For each TCH at least one such predetermined subset should be defined. One of the predetermined subsets is moreover in particular a subset in which SID frame are transmitted in case no user signaling or speech is to be transmitted in a current TDMA frame of the subset. In order to achieve the desired frequency distribution, the SACCH/T frames associated to one TCH are then transmitted with at least a first frequency, while the TDMA frames of the respective subset are transmitted at least with the other frequency.

The predetermined number of TDMA frames corresponds preferably to a SACCH multiframe of 104 TDMA frames, as required by the above mentioned specification TS 45.008 for the measurements of received signal levels.

The invention is of relevance for the positioning of SID frames in half rate transmissions using the first sub-channel sub0 as TCH, since this is the case when the subset specified in the above mentioned document TS 45.008 does not guarantee that the SID frames can be used for level measurements at the mobile terminal.

In a preferred embodiment, the subset of TDMA frames which always have to be transmitted includes the frames with the frame numbers modulo 104 of 39, 41, 4.3, 45, 91, 93, 95, and 97, which are TDMA frames assigned for half rate transmissions to the first sub-channel sub0. With this subset, also interference is equally distributed. But other subsets of TDMA frames fulfilling the requirements of the invention can be found as well.

The object of the invention is also reached with a. corresponding subset of time division multiple access (TDMA) frames of a first sub-channel (sub0) employed for half rate transmissions.

The same TDMA frames can be included in a subset defined for full rate transmissions, in order to keep the structure uniform for half rate and full rate transmissions.

With the invention, at least some of the mandatory TDMA frames can then be used in any situation by a mobile terminal for determining received signal levels for a specific subset, since in each subset, at least one TDMA frame is present which is not transmitted using the frequency employed for BCCH transmissions. The frames that can be used are in particular either the eight SID frames or the four SACCH/T frames of a half rate TCH. Thus, a valid RXLEV_SUB value indicative of the level of received signals can be determined by the mobile terminal and transmitted to the network.

The invention can be employed in particular for GSM and EDGE radio communications systems.

### BRIEF DESCRIPTION OF THE FIGURES

In the following, the invention is explained in more detail for an embodiment of the proposed communications system. The only FIGURE illustrates the distribution of TDMA frames to sub-channels for half rate transmissions as specified in TS 45.001.

### DETAILED DESCRIPTION OF THE INVENTION

A GSM communications system comprises in an embodiment of the invention a base station and a mobile terminal. The base station disposes of two transceivers TRX transmitting TDMA frames with different frequencies. One transceiver is employed for transmitting BCCH frames. At the same time, both transceivers are employed for transmitting TDMA frames of a TCH. The TCH frames are transmitted using a cyclic base band hopping for transmitting signals to mobile terminals, base band hopping being one of different possible implementations of cyclic frequency hopping.

In a current situation, a half rate speech HS call using a discontinuous transmission is established. The call is established to one of the time slot of the TDMA frames of sub-channel sub0 of a TCH/HS, which sub-channel corresponds to the sequence of TDMA frames “T” depicted in part b) of the only FIGURE. For speech transmissions, a subset of TDMA frames is defined for this sub-channel sub0 which includes the frames of frame numbers modulo 104 of “39, 41, 43, 45, 91, 93, 95, 97”. It is ensured by a processor of the base station that the TDMA frames of this subset are always transmitted by transmitting a SID frame in case no user signaling or speech is present.

At present, a parameter PWRC set by the base station controller BSC to which the base station is connected enables power control. This is indicated in the BCCH transmissions by a PWRC bit set to 1 in the system information.

The mobile terminal receives the signals transmitted by the base station in a time slot of sub-channel sub0 and measures the signal levels of the received signals.

On the one hand, the mobile terminal averages the received signal level measurement samples in dBm taken on sub-channel sub0 and those of the corresponding SACCH/T within one SACCH multiframe of 104 frames, i.e the levels are averaged over 52 TDMA frames. In the TDMA multiframe of part b) of the FIGURE this would be all TDMA frames indicated with “T” and the SACCH/T frame indicated with “A”, while four consecutive ones of such a TDMA multiframe constitute a 104 SACCH multiframe. The resulting average value is mapped to a corresponding RXLEV_FULL value between 0 and 63, which RXLEV_FULL value is transmitted to the base station.

On the other hand, the mobile terminal averages the received signal level measurement samples in dBm from the eight SID frames and the four SACCH/T frames of one SACCH multiframe belonging to the first sub-channel sub0. Also this RXLEV_SUB value is transmitted to the base station. Both values are evaluated in the base station for call handling.

The mobile terminal is only allowed, though, to use TDMA frames for averaging which were not transmitted using the BCCH carrier.

In cyclic base band hopping, the frequency employed for each TDMA frame can be calculated according to the following formula:

MAI=(FN+MAIO)mod N (1)

where MAI is an index to a list of used frequencies in a cell listing the frequencies in ascending order, where FN is the respective frame number, where MAIO is the mobile allocation index offset, and where N is the number of the frequencies in the list.

In the described embodiment of the invention, the first transceiver employs a first frequency f1 with a MAIO of 0. This transceiver is working as BCCH TRX (broadcast control channel transceiver). The second transceiver employs a second frequency f2 with a MAIO of 1. This transceiver is working as TCH TRX (traffic channel transceiver). The BCCH TRX is employed in addition for the traffic channels in order to enable a cyclic base band hopping with N=2 frequencies. The list of used frequencies employed in this cell for frequency hopping is thus [f1, f2]. In the described embodiment of the invention, a MAI of 0 thus indicates a used frequency of f1 and a MAI of 1 a used frequency of f2 for a specific TDMA frame.

The half rate call is assigned to a time slot of the first sub-channel sub0 with MAIO 0.

The SACCH/T frames of the first sub-channel sub0 are always sent during even number of frames, more specifically, during frame numbers 12, 38, 64 and 90 of a 104 SACCH multiframe. In the presented embodiment of the invention, this means that they always have a frequency f1, as becomes apparent e.g. for frame number 12 when considering above cited equation (1):

MAI(12+0)mod2=0=>frequency f1

Therefore, the SACCH/T frames of the first sub-channel sub0 are transmitted in the present embodiment on the BCCH carrier, and as a result, the SACCH/T frames are not to be used by the mobile terminal for determining the RXLEV_SUB.

With the subset of mandatory TDMA frames determined according to the invention, the frequency used for the SID frames resulting from equation (1), however, is always f2, as is calculated e.g. for the first TDMA frame 39 of the subset by:

MAI=(39+0)mod2=1=>frequency f2

Also with exchanged MAIO for the two transmitters or with an exchanged frequency employed by the two transmitters BCCH TRX and TCH TRX, the frames with even frame numbers are always transmitted with a different frequency in cyclic base band hopping based on two frequencies than the frames with odd frame numbers, and therefore the SID frames are always transmitted with another frequency than the SACCH/T frames assigned to the first sub-channel sub0. This becomes apparent when evaluating equation (1) for the different possible situations.

In contrast to the resulting transmissions according to specification TS 45.008, therefore always frames with both frequencies are transmitted also in the first sub-channel sub0 during one SACCH multiframe, which enables the mobile terminal to determine in any situation a valid RXLEV_SUB value.

1. Method for positioning mandatory time division multiple access (TDMA) frames which are mandatory to be transmitted during discontinuous transmissions (DTX) of TDMA frames in traffic channels (TCH) by a fixed sub-system of a radio communications system, wherein said TDMA frames are transmitted using cyclic frequency hopping with two different frequencies, and wherein said mandatory TDMA frames are positioned for each channel that can be employed as traffic channel in a way that said mandatory TDMA frames are always transmitted using both of said two different frequencies in the respective channel within a predetermined number of TDMA frames.

2. Method according to claim 1, wherein said mandatory TDMA frames are slow TCH associated control channel (SACCH/T) frames and frames of a subset of TDMA frames predetermined for a traffic channel, and wherein SACCH/T frames assigned to respectively one of the traffic channels are transmitted at least with a first frequency while the TDMA frames of a subset for said TCH are transmitted at least with the other frequency.

3. Method according to claim 2, wherein a silence descriptor (SID) frame is transmitted as mandatory TDMA frame in case no user signaling or speech is to be transmitted in a current TDMA frame of a subset predetermined for speech transmissions on one of the traffic channels.

4. Method according to one of the preceding claims, wherein said predetermined number of TDMA frames is 104.

5. Method according to one of the preceding claims, wherein said traffic channels include sub-channels employed for half rate transmissions.

6. Method according to one of claims 2 to 5, wherein a subset of TDMA frames predetermined for speech transmissions on one of said traffic channels includes the TDMA frames with frame numbers modulo 104 of 39, 41, 43, 45, 91, 93, 95, and 97.

7. Method according to claim 6, wherein said traffic channel is the first of two sub-channels employed for half rate transmissions.

8. Method according to one of the preceding claims, wherein a mobile terminal receiving said transmitted mandatory TDMA frames measures the signal level of said mandatory TDMA frames for determining a RXLEV_SUB value indicative of the level of received signals.

9. Method according to one of the preceding claims employed in a GSM communications system.

10. Method according to one of the preceding claims employed in an EDGE communications system.

11. A radio communications system comprising a fixed sub-system system with
transmitting means for transmitting signals in time division multiple access (TDMA) frames and employing for the transmission of TDMA frames on a traffic channel (TCH) a cyclic frequency hopping with two different frequencies; and
processing means for positioning mandatory TDMA frames for discontinuous transmissions (DTX) in a traffic channel according to one of claims 1 to 10,
said radio communications system further comprising a mobile terminal with means for receiving said mandatory TDMA frames and means for measuring the reception level of said received mandatory TDMA frames.

12. A fixed sub-system for a radio communications system comprising:
transmitting means for transmitting signals in time division multiple access (TDMA) frames and employing for the transmission of TDMA frames on a traffic channel (TCH) a cyclic frequency hopping with two different frequencies; and
processing means for positioning mandatory TDMA frames for discontinuous transmissions (DTX) in a traffic channel according to one of claims 1 to 10.

13. A mobile terminal comprising means for receiving time division multiple access (TDMA) frames and for measuring during discontinuous transmissions (DTX) of a fixed sub-system of a radio communications system employing a cyclic frequency hopping with two different frequencies at least the reception levels of received mandatory TDMA frames, wherein the mandatory TDMA frames were transmitted for each channel employed as traffic channel (TCH) in a way that both frequencies are used within a predetermined number of TDMA frames

14. Subset of time division multiple access (TDMA) frames of a first of two sub-channels used as half rate traffic channels (TCH) for transmissions from a fixed sub-system to mobile terminals of a radio communications system, which subset defines TDMA frames which are mandatory to be transmitted in discontinuous transmissions (DTX) on said first sub-channel, said subset comprising the TDMA frames with frame numbers modulo 104 of “39”, “41”, “143”, “145”, “91”, “193”, “951”, and “197”.
